(19) United States
(12) Patent Application Publication
(10) Pub. No.: US 2006/0260506 A1
(43) Pub. Date: Nov. 23, 2006

(54) Water-based ink for ink-jet recording

(75) Inventors: Satoshi Okuda, Nagoya-shi (JP); Narumi Koga, Nagoya-shi (JP); Kazuma Goto, Nagoya-shi (JP); Hideo Ohira, Tajimi-shi (JP); Junichiro Sugimoto, Aichi-ken (JP); Masaya Fujioka, Nagoya-shi (JP); Shunichi Higashiyama, Yokkaichi-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/435,845

(22) Filed: May 18, 2006

(30) Foreign Application Priority Data
May 20, 2005 (JP) 2005-147756

(51) Int. Cl. C09D 11/00

(52) U.S. Cl. 106/31.13

(57) ABSTRACT

A water-based ink for ink-jet recording includes a reactive dye which forms chloride ions in the ink, benzotriazole, carboxybenzotriazole, water and a water soluble organic solvent. Examples of the reactive dye which forms chloride ions in the ink include triazine based reactive dyes and the like.

### BACKGROUND OF THE INVENTION

1. Field of the Invention

The present invention relates to a water-based ink for ink-jet recording.

2. Description of the Related Art

A printer technology in an ink-jet recording method is a recording technology for forming an image by allowing several color inks of basic colors to selectively land on paper as fine droplets of several pL to several tens of pL by means of a bubble method a piezo method, or the like. In the bubble method, ink is ejected from fine nozzles through bubbles generated by rapid heating. In the piezo method, ink is ejected from fine nozzles by use of a piezoelectric element which deforms upon the application of voltage.

The ink-jet recording method has the following advantages: high text printing quality and high image printing quality can be obtained by controlling the ejection of the fine droplets; and an image with color reproduction in nearly full color and without graininess can be formed by allowing the fine droplets of several pL to land on paper with high accuracy. However, in order to maintain the landing accuracy of the fine droplets for a long time, various technologies are required.

Particularly, in order to eject ink from fine nozzles with high accuracy, dust and impurities must be removed from the ink during the manufacturing of the ink. Further, there is a demand that the generation of exogenous materials such as precipitates be prevented in the ink for a long time after the manufacturing. Hence, in a water-based ink for ink-jet recording, dust and impurities are removed therefrom by microfiltration during the manufacturing. Moreover, in a printer employing the ink, all parts to be in contact with the ink are formed of a material in which the amount of compounds dissolving into the ink is reduced as much as possible, and these parts are sufficiently cleaned to be employed in the printer.

However, an ink-jet head member mounted on a printer is generally formed of a metal. Therefore, the failure of the ink-jet head itself may occur due to the corrosion of the metal. Further, the corroded metal may be precipitated in the ink to cause a filter or nozzles of the ink-jet head to be clogged. Particularly, if the ink-jet head has an alloy part formed of iron and nickel, and if the ink is a water-based ink, metal ions such as iron ion, nickel ion or the like dissolve into the ink. Then insoluble inorganic salts are formed, and the metal member itself is also deteriorated. Therefore, the filter or the nozzles are clogged, causing a problem that high landing accuracy is not obtained.

Representative materials causing the alloy part formed of iron and nickel to corrode include chlorine ions and chloride ions contained in the ink (these ions are hereinafter collectively referred to as chloride ions).

Normally, the surface of a metal is covered with a layer of the oxide thereof. Even if the oxide layer is dissolved, a new oxide layer is formed by ambient oxygen. Since the reaction is in equilibrium, the surface appears to be not corroded for practical use. However, if chloride ions are present, the specific adsorption of the chloride ions occurs on the metal surface to thereby inhibit the re-formation of the oxide layer. Therefore, the oxide layer on the metal surface is destroyed with time, and the corrosion of the metal rapidly proceeds from the portion on which the specific adsorption of the chloride ions has occurred.

In view of the above, an anticorrosive such as benzotriazole is often added to a water-based ink for ink-jet recording for preventing the corrosion of metal (U.S. Pat. No. 6,447,592).

In practice, for the case where a coloring agent contained in ink is a direct dye, an acid dye, a basic dye or the like, even when the ink contains chloride ions in an amount of several hundreds of ppm, the corrosion of metal can be suppressed by adding an anticorrosive such as benzotriazole.

However, the abovementioned dyes have problems. That is, few of the direct dyes have vivid color and sufficient water solubility. Further, most of the acid dyes have insufficient dyeing properties on ordinary paper, and most of the basic dyes have insufficient light fastness. In addition, few of the direct, acid and basic dyes enable printing with high density and excellent color development.

On the other hand, a reactive dye is a dye known to enable printing with high density and excellent color development. However, the reactive dye is easily decomposed as compared to the direct, acid and basic dyes. Hence, if the reactive dye contains chlorine as in, for example, chlorotriazine, the amount of chloride ions in the ink increases due to the decomposition of the reactive dye during long-term storage. Therefore, metal parts employed in an ink-jet head are likely to be corroded, causing a problem that the corrosion cannot be prevented even when an anticorrosive such as benzotriazole is added.

### SUMMARY OF THE INVENTION

The present invention has been made to solve the above problems. Accordingly, it is an object of the present invention to provide a water-based ink for ink-jet recording containing a reactive dye which enables printing with high density and excellent color development. In addition, this water-based ink can prevent corrosion of metal parts employed in an ink-jet head and can provide high landing accuracy of fine ink droplets for a long time.

In a water-based ink for ink-jet recording, if a reactive dye which enables printing with high density and excellent color development but decomposes in the ink to form chloride ions is employed as a coloring agent, the corrosion of metal parts employed in an ink-jet head must be prevented. The present inventors have found that, if such a reactive dye is employed, the combined use of benzotriazole and carboxybenzotriazole in the ink is effective for preventing the corrosion of the metal parts. Thus, the present invention has been completed.

Accordingly, the present invention provides a water-based ink for ink-jet recording including a reactive dye which forms chloride ions in the ink, benzotriazole, carboxybenzotriazole, water and a water soluble organic solvent.

According to the water-based ink for ink-jet recording of the present invention, printing can be performed with high density and excellent color development, and the corrosion of metal parts employed in an ink-jet head can be prevented. In addition, high landing accuracy of fine ink droplets can be maintained for a long time.

### DETAILED DESCRIPTION OF THE PREFERRED EMBODIMENTS

An embodiment of the present invention will next be described.

The water-based ink for ink-jet recording of the present invention contains, as a coloring agent, a reactive dye which forms chloride ions in the ink and characterized by further comprising both benzotriazole and carboxybenzotriazole as an anticorrosive.

Examples of the reactive dye which forms chloride ions in the ink include reactive dyes having a substituent containing a chlorine atom such as triazine based reactive dyes, sulfatoethyl sulfone based reactive dyes, and pyrimidine based reactive dyes. Specific examples of the reactive dyes include, but are not limited to, C. I. Reactive Yellows 2, 3, 6, 12, 18, 95, and 99; C. I. Reactive Oranges 2, 5, 9, 12, 13 and 20; C. I. Reactive Reds 3, 3:1, 4, 7, 12, 13, 15, 16, 24, 29, 31, 32, 33, 43, 45, 46, 58, 59 and 226; C. I. Reactive Violets 1 and 2; C. I. Reactive Blues 2, 3, 5, 7, 13, 14, 15, 15:1, 25, 26, 39, 40, 41, 46, 49 and 176; C. I. Reactive Greens 5 and 8; C. I. Reactive Browns 1, 2, 7, 8, 9, 11 and 14; C. I. Reactive Blacks 1, 3, 8, 10, 12 and 13; and the like.

The reactive dyes may be employed alone or as a mixture of two or more. By employing the reactive dyes as a mixture of two or more, the desired color can be obtained which cannot be obtained by a single dye.

The amount of the reactive dye is appropriately determined based on the hue and the density required for a printing object. If the amount is too low, the color is not satisfactorily developed on a recording material. If the amount is too high, a nozzle of an ink-jet head tends to be clogged. Thus, the amount of the reactive dye with respect to the total amount of the ink is preferably about 0.1 to about 20 wt. %, and more preferably about 0.3 to about 15 wt. %.

The water-based ink for ink-jet recording of the present invention may contain, as a coloring agent, a reactive dye other than the abovementioned reactive dyes which form chloride ions in the ink, in accordance with need. Further, this water-based ink may contain a direct dye, an acid dye or a basic dye, and may also contain a pigment.

Each of the benzotriazole and the carboxybenzotriazole contained in the water-based ink for ink-jet recording of the present invention serves as an anticorrosive which prevents the corrosion of metal and has an anticorroding action to some extent. However, if only one of these is employed, the anticorroding effect cannot be sufficiently obtained in the ink containing the reactive dye which forms chloride ions in the ink. The anticorroding effect can be sufficiently obtained for a long time only when these are employed in combination.

The reason for this has not been fully elucidated but may be as follows. That is, benzotriazole has the effect of promoting the formation of a passivation layer but has somewhat low capability of protecting the passivation layer from transpassivation. Therefore, the formed passivation layer cannot be retained by benzotriazole alone in the environment where the concentration of chloride ions in the ink is high. On the other hand, carboxybenzotriazole has a small effect on promoting the formation of the passivation layer but has strong capability of protecting the once-formed passivation layer from transpassivation. Therefore, by employing benzotriazole and carboxybenzotriazole in combination, a dense passivation layer can be formed with the help of benzotriazole, and the formed passivation layer can be protected from transpassivation with the help of carboxybenzotriazole. In this manner, an excellent anticorroding effect may be obtained which protects metal from corrosion even in a severe environment for the corrosion of metal. The anticorroding effect by the combined use of benzotriazole and carboxybenzotriazole is strong enough to prevent the corrosion of an ink-jet head. Therefore, in the water-based ink for ink-jet recording of the present invention, no other anticorrosive are required to be added in addition to benzotriazole and carboxybenzotriazole.

If the amount of benzotriazole is too low, the anticorroding effect is not obtained. If the amount is too high, benzotriazole causes the dye to be precipitated upon long term storage, thereby deteriorating the long term storage stability of the ink. Therefore, the amount of benzotriazole with respect to the total amount of the ink is preferably about 0.05 to about 0.5 wt. %, and more preferably about 0.1 to about 0.5 wt. %.

If the amount of carboxybenzotriazole is too low, the anticorroding effect is not obtained. If the amount is too high, carboxybenzotriazole does not dissolve into the ink. Therefore, the amount of carboxybenzotriazole with respect to the total amount of the ink is preferably about 0.01 to about 0.04 wt. %.

Preferably, the water employed in the water-based ink for ink-jet recording of the present invention is not ordinary water but high purity water such as ion-exchanged water, distilled water, pure water or ultrapure water.

The water soluble organic solvent employed in the water-based ink for ink-jet recording of the present invention is employed as a humectant. The purpose of the use of the humectant is to prevent solids from being precipitated from the ink and to prevent the ink from being dried and solidified, and these are mainly due to evaporation of water at the end of an ink-jet head. Hence, a solvent having a low volatility is desirably employed. Specific examples of the humectant include,but are not limited to, polyols such as ethylene glycol, diethylene glycol, triethylene glycol, polyethylene glycol, propylene glycol, dipropylene glycol, tripropylene glycol, polypropylene glycol, 1,3-butanediol, 1,5-pentanediol, 1,6-hexanediol, glycerin, 1,2,6-hexanetriol, 1,2,4-butanetriol, 1,2,3-butanetriol and petriol; nitrogen-containing heterocyclic compounds such as N-methyl-2-pyrrolidone, N-hydroxyethyl-2-pyrrolidone, 2-pyrrolidone, 1,3-dimethylimidazolidinone and ε-caprolactam; and the like. The humectants may be used alone or in combination of two or more thereof.

The amount of the humectant with respect to the total amount of the ink is preferably about 5 to about 40 wt. %, and more preferably about 10 to about 35 wt. %. If the amount is less than about 5 wt. %, the wetting action is not satisfactory, thereby causing problems such as the precipitation of solids and the drying and solidification of the ink upon the evaporation of water in the ink. The amount exceeding about 40 wt. % is not preferable since the viscosity of the ink unnecessarily increases to cause problems such as the inability to eject the ink and the significant retardation of the ink drying on a recording material.

A water soluble organic solvent serving as a penetrant for controlling penetrability may be mixed with the water-based ink for ink-jet recording of the present invention in accordance with need. Polyol alkyl ethers can be used as the penetrant, and specific examples of the penetrant include, but are not limited to, propylene glycol propyl ether, diethylene glycol methyl ether, diethylene glycol butyl ether, diethylene glycol i-butyl ether, diethylene glycol dimethyl ether, diethylene glycol diethyl ether, diethylene glycol dibutyl ether, dipropylene glycol methyl ether, dipropylene glycol propyl ether, dipropylene glycol i-propyl ether, dipropylene glycol butyl ether, dipropylene glycol dimethyl ether, dipropylene glycol dipropyl ether, dipropylene glycol dibutyl ether, triethylene glycol methyl ether, triethylene glycol butyl ether, tripropylene glycol methyl ether, tripropylene glycol butyl ether, triethylene glycol dimethyl ether, triethylene glycol dibutyl ether, tripropylene glycol dimethyl ether, tripropylene glycol dibutyl ether and the like.

If the amount of the penetrant is too low, the penetrability of the ink is not satisfactory. If the amount is too high, blurring such as feathering tends to occur due to excessively high penetrability. Therefore, the amount of the penetrant with respect to the total amount of the ink is preferably about 0.05 to about 15 wt. %, and more preferably about 0.1 to about 10 wt. %.

In addition to the abovementioned humectant and penetrant, a monohydric alcohol such as ethanol or isopropyl alcohol may be employed for the purpose of controlling the drying characteristics of the ink and the penetrability of the ink into a recording material.

Preferably, the water-based ink for ink-jet recording of the present invention may further contain a surfactant for adjusting the surface tension of the ink. This surfactant is employed for the purpose of satisfying requirements such as the stability of ink ejection, the introducing characteristics of the ink into an ink-jet head, and the text printing quality. Examples of the surfactant include, but are not limited to: anionic surfactants produced by Kao Corporation such as EMAL (a registered trademark) series, LATEMUL (a registered trademark) series, VENOL (a registered trademark), NEOPELEX (a registered trademark) series, NS SOAP, KS SOAP, OS SOAP and PELEX (a registered trademark) series; anionic surfactants produced by Lion Corporation such as LIPOLAN (a registered trademark) series, LIPON (a registered trademark) series, SUNNOL (a registered trademark) series, LIPOTAC (a registered trademark) TE, ENAGICOL (a registered trademark) series, LIPAL (a registered trademark) series and LOTAT (a registered trademark) series; nonionic surfactants produced by Kao Corporation such as EMULGEN (a registered trademark) series, RHEODOL (a registered trademark) series, EMASOL (a registered trademark) series, EXCEL (a registered trademark) series, EMANON (a registered trademark) series, AMIET (a registered trademark) series and AMINON (a registered trademark) series; nonionic surfactants produced by Lion Corporation such as DOBANOX (a registered trademark) series, LEOCOL (a registered trademark) series, LEOX (a registered trademark) series, LAOL, LEOCON (a registered trademark) series, LIONOL (a registered trademark) series, CADENAX (a registered trademark) series, LIONON (a registered trademark) series and LEOFAT (a registered trademark) series; and the like. These surfactants may be employed alone or as a mixture of two or more.

If the amount of the surfactant is too low, the wettability to an ink flow passage in an ink-jet head may be significantly lowered in some cases, thereby deteriorating the initial introducing characteristics of the ink. If the amount is too high, the penetrability of the ink into a recording material such as recording paper becomes too high, thereby causing problems. For example, text printing quality and image printing quality are adversely affected, and the periphery of nozzles of an ink-jet head gets excessively wet with the ink. Consequently, the stable ejection of the ink is inhibited. Therefore, the amount of the surfactant with respect to the total amount of the ink is preferably about 0.01 to about 10 wt. %, and more preferably about 0.1 to about 5 wt. %.

Preferably, in terms of suppressing hydrolysis of dye, the pH of the water-based ink for ink-jet recording of the present invention is adjusted to about 5 to about 7. A known pH modifier may be employed in accordance with need.

In addition to the above, a dye dissolving agent, a preservative-mildewproofing agent, and the like may be added in accordance with need. Moreover, values of thermal physical properties (such as specific heat, thermal expansion coefficient and thermal conductivity) may be adjusted if the ink is applied to an ink-jet recording method of a type utilizing the action of thermal energy to eject the ink.

Devices for employing the water-based ink for ink-jet recording of the present invention include an ink-jet recording device having an ink-jet head which has a metal part formed of nickel and/or an alloy containing nickel in an ink supply path to an ejection part. Such an ink-jet head has fine nozzles and ink supply paths to the respective fine nozzles, and an image is formed on the surface of a recording material by ejecting fine droplets from the nozzles. Examples of such an ink-jet head include: the ink-jet head disclosed in Japanese Patent Application Laid-Open No. H10-278265 in which an electrode formed of nickel is arranged in the inner surface of the ink supply paths; the ink-jet head disclosed in Japanese Patent Application Laid-Open No. 2002-19102 in which a plurality of plates laminated so as to contain the ink supply paths thereinside are composed of 42% nickel alloy steel; and the like.

The water-based ink for ink jet recording of the present invention does not cause a metal part formed of nickel and/or an alloy containing nickel to be deteriorated even when the ink is in contact with the metal part for a long time. Therefore, the present water-based ink can be suitably employed in the ink-jet recording device having the ink-jet head having the metal part formed of nickel and/or an alloy containing nickel. In detail, this metal part is employed in a portion, such as the inside of the ink supply paths, in direct contact with the ink as described above.

### EXAMPLES

Examples in which the present invention is embodied and Comparative Examples will next be described.

(A) Preparation of Inks

### Example 1

3.0 wt. % of C. I. Reactive Red 31; 25.5 wt. % of glycerin; 2.0 wt. % of dipropylene glycol propyl ether; 0.2 wt. % of SUNNOL (a registered trademark) DL-1430 (alkyl ether sulfate, a surfactant, product of Lion Corporation); 0.03 wt. % of PROXEL GXL (S) (a preservative-mildewproofing agent, product of Arch Chemicals, Inc.); 0.5 wt. % of benzotriazole; 0.04 wt. % of carboxybenzotriazole; and 68.73 wt. % of pure water were sufficiently mixed under stirring. Subsequently, the mixture was filtrated with a membrane filter having a pore size of 1 μm.

### Examples 2 to 6 and Comparative Examples 1 to 8

The same procedure as in Example 1 was repeated except that the ink composition was changed as shown in Table 1 to prepare the inks. The inks for Example 4 and Comparative Examples 3 and 6 were measured for pH.

(B) Evaluation of Metal Corrosion

For the ink prepared in each of the Examples and Comparative Examples, metal corrosion was evaluated as follows.

(1) First, in order to examine the long-term stability of the ink, the ink was filled into a well-washed glass bottle, and the glass bottle was allowed to stand in a thermostatic bath at 60° C. for two weeks. Subsequently, the ink was transferred to a beaker, and the beaker was immersed in a thermostatic bath. The temperature of the thermostatic bath was set to 60° C., and the beaker was allowed to stand therein for 30 to 60 minutes for adjusting the temperature of the ink in the beaker to 60° C.

(2) A working electrode metal piece made of 42% nickel alloy steel was immersed into an alkaline degreasing agent (ACE CLEAN 850, product of OKUNO Chemical Industries Co., Ltd.) and was allowed to stand therein at 60° C. for 5 minutes. Subsequently, the metal piece was washed with pure water.

(3) The working electrode metal piece and a platinum plate serving as a counter electrode were connected, and a current density was measured in the electric potential ranges of −600 mV to 0 mV and 0 mV to +400 mV by use of a silver-silver chloride standard reference electrode.

In the measurement sequence, the measurement in 0 mV to +400 mV was first performed. If the current density in the above voltage range was less than 200 μA/cm², a passivation layer was assumed to exist on the working electrode metal piece, and the measurement in −600 mV to 0 mV was further performed to examine the formation ability of the passivation layer. If the current density in 0 mV to +400 mV was 200 μA/cm² or higher, the measurement in −600 mV to 0 mV was not performed. An electrochemical measurement system (HZ-3000, product of HOKUTO DENKO Corporation) was employed as the measurement apparatus.

(4) The obtained current density was evaluated in three ratings (ranks A, B and C) by use of the following criteria. The results are shown in Table 1.

A: The current density is less than 100 μA/cm².

B: The current density is 100 μA/cm² or more and less than 200 μA/cm².

C: The current density is 200 μA/cm² or more.

When the current density in 0 mV to +400 mV is less than 100 μA/cm², almost no corrosion current flows to the working electrode metal piece due to the formation of the passivation layer. Therefore, even in practical use, metal parts in an ink-jet head are not corroded by oxidization, and the filter and the nozzles of the ink-jet head are not clogged, thereby obtaining high landing accuracy. Moreover, for the case where the current density in −600 mV to 0 mV is less than 100 μA/cm², even if the passivation layer is destroyed for some reason, the sufficient formation ability of the passivation layer is exerted. Therefore, even in practical use, the passivation layer has sufficient resistance to chloride ions in the ink.

In the case where the current density in 0 mV to +400 mV is 100 μA/cm² or higher and less than 200 μA/cm², the corrosion current of the working electrode metal piece is considered to be almost suppressed due to the formation of the passivation layer. Therefore, even in practical use, the metal parts in an ink-jet head are prevented from being corroded by oxidization. In this case, although the landing accuracy is slightly lowered, high image quality can be obtained which does not exhibit problems in visual observation.

In the case where the current density in 0 mV to +400 mV is 200 μA/cm² or more, the corrosion current flows to the working electrode metal piece due to anodic oxidation. Therefore, even in practical use, the metal material in an ink-jet head is corroded, and thus high landing accuracy is not obtained.

TABLE 1

| | | Example | | | | | | Comparative Example | | | | | | | |
|---|---|---|---|---|---|---|---|---|---|---|---|---|---|---|---|
| | | 1 | 2 | 3 | 4 | 5 | 6 | 1 | 2 | 3 | 4 | 5 | 6 | 7 | 8 |
| Ink composition | C. I. Reactive Red 31 | 3.0 | 3.0 | 3.0 | 3.0 | 3.0 | 3.0 | 3.0 | 3.0 | 3.0 | 3.0 | 3.0 | 3.0 | 3.0 | 3.0 |
| (wt. %) | Glycerin | 25.5 | 25.5 | 25.5 | 25.5 | 25.5 | 25.5 | 25.5 | 25.5 | 25.5 | 25.5 | 25.5 | 25.5 | 25.5 | 25.5 |
| | Dipropylene glycol | 2.0 | 2.0 | 2.0 | 2.0 | 2.0 | 2.0 | 2.0 | 2.0 | 2.0 | 2.0 | 2.0 | 2.0 | 2.0 | 2.0 |
| | propyl ether | | | | | | | | | | | | | | |
| | Anionic surfactant (*1) | 0.2 | 0.2 | 0.2 | 0.2 | 0.2 | 0.2 | 0.2 | 0.2 | 0.2 | 0.2 | 0.2 | 0.2 | 0.2 | 0.2 |
| | Preservative- | 0.03 | 0.03 | 0.03 | 0.03 | 0.03 | 0.03 | 0.03 | 0.03 | 0.03 | 0.03 | 0.03 | 0.03 | 0.03 | 0.03 |
| | mildewproofing agent (*2) | | | | | | | | | | | | | | |
| | Benzotriazole | 0.5 | 0.5 | 0.2 | 0.1 | 0.1 | 0.05 | 0.5 | 0.3 | 0.1 | 0.1 | 0.1 | — | — | — |
| | Carboxybenzotriazole | 0.04 | 0.01 | 0.02 | 0.04 | 0.01 | 0.04 | — | — | — | — | — | 0.04 | 0.04 | 0.04 |
| | Tolyltriazole | — | — | — | — | — | — | — | — | — | 0.04 | — | — | 0.1 | — |
| | Nitrobenzotriazole | — | — | — | — | — | — | — | — | — | — | 0.04 | — | — | 0.1 |
| | Pure water | *3 | *3 | *3 | *3 | *3 | *3 | *3 | *3 | *3 | *3 | *3 | *3 | *3 | *3 |
| pH | | | | | 5.54 | | | | | 7.20 | | | 5.52 | | |
| Evaluation of | 0 to 400 mV | A | A | A | A | A | B | C | C | C | C | C | A | C | C |
| metal corrosion | −600 to 0 mV | A | A | A | A | A | A | — | — | — | — | — | C | — | — |

(*1) SUNNOL DL-1430 (alkyl ether sulfate, product of Lion Corporation).
(*2) PROXEL GXL (S) (product of Arch Chemicals, Inc.).
*3 Balance

In Example 1 to 6, benzotriazole and carboxybenzotriazole are employed in combination in the ink. Therefore, as shown in Table 1, excellent results were obtained in the evaluation of metal corrosion.

On the other hand, in Comparative Examples 1 to 3 and 6, either one of benzotriazole and carboxybenzotriazole is employed as an anticorrosive. Therefore, the results of the evaluation of metal corrosion were poor.

Moreover, in Comparative Examples 4, 5, 7 and 8, either one of benzotriazole and carboxybenzotriazole, and an anticorrosive other than benzotriazole and carboxybenzotriazole are employed in combination in the ink. However, the results of the evaluation of metal corrosion were poor.

As described above, it has been found that significant anticorroding effects are exerted due to the interaction of the combination use of benzotriazole and carboxybenzotriazole in the ink.

Further, based on the results of the evaluation of metal corrosion, the inks of Examples 1 to 6 and Comparative Examples of 1 to 8 were actually mounted on ink-jet recording devices and were allowed to stand at room temperature for one year. Subsequently, printing evaluation was performed. As the evaluation results, in the ink ink-jet recording devices equipped with the inks of Examples 1 to 6, high landing accuracy was found to be maintained. However, in the ink-jet recording devices equipped with the inks of Comparative Examples 1 to 8, the landing accuracy was lowered in some nozzles, and some nozzles were unable to eject the ink, thereby deteriorating printing quality.

According to the water-based ink for ink-jet recording of the present invention, printing with high density and excellent color development can be maintained with high landing accuracy for a long time. Therefore, the present water-based ink is useful when a high quality image is formed by use of an ink-jet recording device.

The entire disclosure of the specification, claims and summary of Japanese Patent Application No. 2005-147756 filed on May 20, 2005 is hereby incorporated by reference.

What is claimed is:

1. A water-based ink for ink-jet recording, comprising: a reactive dye which forms chloride ions in the ink; benzotriazole; carboxybenzotriazole; water; and a water soluble organic solvent.

2. The water-based ink for ink-jet recording according to claim 1, wherein the reactive dye which forms chloride ions in the ink is a triazine based dye.

3. The water-based ink for ink-jet recording according to claim 2, wherein the triazine based dye is C. I. Reactive Red.

4. The water-based ink for ink-jet recording according to claim 3, wherein the triazine based dye is C. I. Reactive Red 31.

5. The water-based ink for ink-jet recording according to claim 1, wherein an amount of benzotriazole with respect to a total amount of the water-based ink is about 0.05 to about 0.5 wt. %.

6. The water-based ink for ink-jet recording according to claim 1, wherein an amount of carboxybenzotriazole with respect to a total amount of the water-based ink is about 0.01 to about 0.04 wt. %.

7. The water-based ink for ink-jet recording according to claim 1, for use in an ink-jet recording device comprising an ink-jet head having a metal part formed of nickel and/or an alloy containing nickel.
